(19) United States
(12) Patent Application Publication
(10) Pub. No.: US 2011/0105222 A1
(43) Pub. Date: May 5, 2011

(54) MANAGING WAGERING GAME CONTENT

(76) Inventors: Mark B. Gagner, West Chicago, IL (US); Craig J. Sylla, Round Lake, IL (US)

(21) Appl. No.: 13/000,792

(22) PCT Filed: Jun. 22, 2009
(86) PCT No.: PCT/US2009/048186

§ 371 Date: Dec. 22, 2010

Related U.S. Application Data
(60) Provisional application No. 61/074,838, filed on Jun. 23, 2008.

(51) Int. Cl. A63F 9/24; A63F 13/00

(52) U.S. Cl. 463/29; 463/42; 463/30

(57) ABSTRACT

In some embodiments, a wagering game machine comprises a secure hard disk drive including at least one secure partition configured to store wagering game assets for use in presenting wagering games, and unsecured partitions configured to store wagering game content. The secure hard disk drive can also include an access controller configured to receive a request to access the wagering game assets and a first access key. The access controller can also deny the access request if the first access key does not match a second access key, and allow access to the wagering game assets if the first access key matches the second access key. The wagering game machine can also include a wagering game controller configured to send the request to access the wagering game assets, and to present, after being allowed access to the wagering game assets, wagering game using the wagering game assets.

### RELATED APPLICATIONS

This application claims the priority benefit of U.S. Provisional Application Ser. No. 61/074,838 filed Jun. 23, 2008.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2009, WMS Gaming, Inc.

### FIELD

Embodiments of the inventive subject matter relate generally to wagering game systems, and more particularly to techniques for controlling access to content in wagering game systems.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### SUMMARY

In some embodiments, a wagering game system is configured to render a hard disk drive unusable for presenting wagering games if the hard disk drive is moved between wagering game machines. In some embodiments, the system comprises a key server configured to transmit a first key to a first wagering game machine and a second key to a second wagering game machine; the first wagering game machine includes, a first wagering game controller configured to receive the first key from the key server and to facilitate presentation of a first group of wagering games; a first hard disk drive includes, a first group of secure partitions configured to store a first group of wagering game assets, wherein the wagering game assets are necessary for presenting the first group of wagering games; and a first access controller configured to receive the first key before providing the first group of wagering game assets; the second wagering game machine includes, a second wagering game controller configured to receive the second key from the key server and facilitate presentation of a second group of wagering games; a second hard disk drive including, a second group of secure partitions configured to store a second group of wagering game assets, wherein the wagering game assets are necessary for presenting the second group of wagering games; and an access controller configured to receive the second key before provision of the second group of wagering game assets.

In some embodiments, the key server is configured to send the first key to the first wagering game controller and not the second wagering game controller.

In some embodiments, the first access controller is configured to encrypt the first group of wagering game assets before storage on the first group of secure partitions, and wherein the second access controller is configured to encrypt the second group of wagering game assets before storage on the second group of secure partitions.

In some embodiments, the keys are represented by one or more of an alphanumeric character string and a signal represented in binary code.

In some embodiments, the key server is further configured to verify a license for the first and second groups of wagering game assets before transmission of the first and second keys.

In some embodiments, a wagering game machine comprises a secure hard disk drive including: at least one secure partition configured to store wagering game assets for use in presenting wagering games; unsecured partitions configured to store wagering game content; an access controller configured to receive a request to access the wagering game assets and a first access key, to deny the access request if the first access key does not match a second access key, and to allow access to the wagering game assets if the first access key matches the second access key; a wagering game controller configured to send the request to access the wagering game assets, and to present, after being allowed access to the wagering game assets, to a present wagering game using the wagering game assets.

In some embodiments, the access controller is further configured to deny the request if the second access key is expired, wherein expiration of the second access key is based a license term associated with the wagering game assets.

In some embodiments, the access controller is further configured to receive the second access key from a license controller after a license royalty has been paid.

In some embodiments, the wagering game assets include one or more of audio content, video content, pay tables, and configuration information.

In some embodiments, the wagering game machine, the secure hard disk drive further includes, an encryption unit configured to encrypt, based on the second access key, the wagering game assets for storage on the at least one secure partition, and to decrypt, based on the second access key, the wagering game assets after the access controller allows access to the wagering game assets.

In some embodiments, a method comprises storing wagering game assets on secure partitions of a hard disk drive; storing a first group of access keys in the hard disk drive, wherein each of the access keys is associated with an expiration date; receiving a request for some of the wagering game assets and another access key; determining that the other access key matches one of the first group of access keys; determining that the expiration date associated with the one of the first group of access keys has not passed; providing the requested wagering game assets; and presenting, using the wagering game assets, wagering games.

In some embodiments, the method further comprises encrypting the game assets using the first group of access keys, wherein the encrypting occurs before the storing of the wagering game assets; and decrypting the game assets using the first group of access keys, wherein the decrypting occurs before the providing.

In some embodiments, the wagering game assets include one or more of audio content, animation content, prerecorded video content, graphical images, and pay tables.

In some embodiments, each key's expiration date is associated with a license to use the game assets.

In some embodiments, each key's expiration date coincides with an expiration date of a license for the wagering game assets.

In some embodiments, a wagering game network comprises a plurality of wagering game machines, wherein one or more of the wagering game machines includes, a secure hard disk drive includes, wagering game assets for use in presenting wagering games; and an access controller configured to receive access keys; grant access to the wagering game assets if the access keys match stored keys; deny access to the wagering game assets if the access keys do not match the stored keys; a central processing unit configured to initiate receipt of the access keys over a network; transmit the access keys to the secure hard disk drive; receive the wagering game assets from the secure hard disk drive; and present wagering games using the wagering game assets; a licensing server configured to distribute, over a network, the access keys to the one or more wagering game machines; a wagering game server configured to deliver, over the network, the wagering game assets to the one or more wagering game machines.

In some embodiments, the wagering game assets include one or more of audio content, animation content, prerecorded video content, graphical images, and pay tables.

In some embodiments, the access keys expire in accordance to a license to use the game assets.

In some embodiments, the central processing unit does not validate the wagering game assets after receipt from the wagering game server.

In some embodiments, the central processing unit is further configured to receive, from the hard disk drive, a first identifier associated of the hard disk drive; and halt operations if the first identifier does not match a second identifier accessible to the processor.

In some embodiments, an apparatus comprises means for storing wagering game assets on secure partitions of a hard disk drive; means for storing a first group of access keys in the hard disk drive, wherein each of the access keys is associated with an expiration date; means for receiving a request for some of the wagering game assets and another access key; means for determining that the other access key matches one of the first group of access keys; means for determining that the expiration date associated with the one of the first group of access keys has not passed; means for providing the requested wagering game assets; and means for presenting, using the wagering game assets, wagering games.

In some embodiments, the apparatus further comprises means for encrypting the game assets using the first group of access keys, wherein the encrypting occurs before storage of the wagering game assets; and decrypting the game assets using the first group of access keys, wherein the decrypting occurs before the provision of the requested wagering game assets.

In some embodiments, the wagering game assets include one or more of audio content, animation content, prerecorded video content, graphical images, and pay tables.

In some embodiments, each key's expiration date is associated with a license to use the game assets.

In some embodiments, each key's expiration date coincides with an expiration date of a license for the wagering game assets.

### BRIEF DESCRIPTION OF THE FIGURES

Embodiments of the invention are illustrated in the Figures of the accompanying drawings in which:

FIG. 1 is a block diagram illustrating a wagering game machine architecture, according to example embodiments of the invention;

FIG. 2 is a dataflow diagram illustrating operations for accessing wagering game assets stored on secure or partitions of a trusted hard disk drive, according to some embodiments of the invention;

FIG. 3 is a block diagram illustrating a wagering game network 300, according to example embodiments of the invention;

FIG. 4 is a dataflow diagram illustrating a method for managing digital rights associated with wagering game content, according to some embodiments of the invention;

FIG. 5A is a dataflow diagram illustrating how a key server delivers keys for accessing trusted hard disk drives, according to some embodiments of the invention;

FIG. 5B shows the wagering game machines after the key server 502 has distributed keys to each wagering game controller 504;

FIG. 5C shows how trusted HDDs are “locked” when they are moved to different wagering game machines; and

FIG. 6 shows an example embodiment of a wagering game machine.

### DESCRIPTION OF THE EMBODIMENTS

This description of the embodiments is divided into five sections. The first section provides an introduction to embodiments of the invention, while the second section describes example wagering game machine architectures, wagering game networks, digital rights management, and techniques for resisting attacks. The third section describes example wagering game machines in more detail. The fifth section presents some general comments.

### INTRODUCTION

This section provides an introduction to some embodiments of the invention.

Wagering game machines often store wagering game results, player account information, and other sensitive information. This information is an attractive target for hackers and cheaters. This attack risk makes storing sensitive data on wagering game machines unattractive to game operators. As a result, wagering game machines often transmit sensitive information to servers residing in secure vaults or backrooms. As wagering game networks scale to include more wagering game machines, transmitting sensitive information over networks may consume significant network bandwidth. Some embodiments of the inventive subject matter securely store sensitive information on wagering game machines, reducing attack risks and reducing the need for transmitting sensitive information to servers.

Attacks are not limited to accessing sensitive wagering game information. Some attackers may attempt to duplicate content without obtaining proper licenses. Other attackers may try to use wagering game components in unauthorized ways. For example, attackers may copy wagering game content or move components to different wagering game machines. Some embodiments of the inventive subject matter make wagering game machines resistant to unauthorized duplication and tampering.

In some embodiments of the inventive subject matter, wagering game machines include trusted hard disk drives that preclude access to certain “secure patricians” unless proper access credentials (e.g., key, signal, password, etc.) are provided. Such wagering game machines can use the trusted hard disks and other logic to implement digital rights management methods that resist unauthorized use and copying of wagering game content. Additionally, some embodiments include logic that prevents unauthorized movement of trusted hard disks between wagering game machines.

While this section describes some features, the following sections describe many other features and embodiments.

### Environment and Operations

The following sections describe an example operating environment and presents structural aspects of some embodiments. The following sections include discussion about wagering game machine architectures, wagering game networks, digital rights management, and techniques for resisting attacks.

The following discussion describes operations performed by some embodiments. Those operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations described herein.

### Wagering Game Machine Architecture

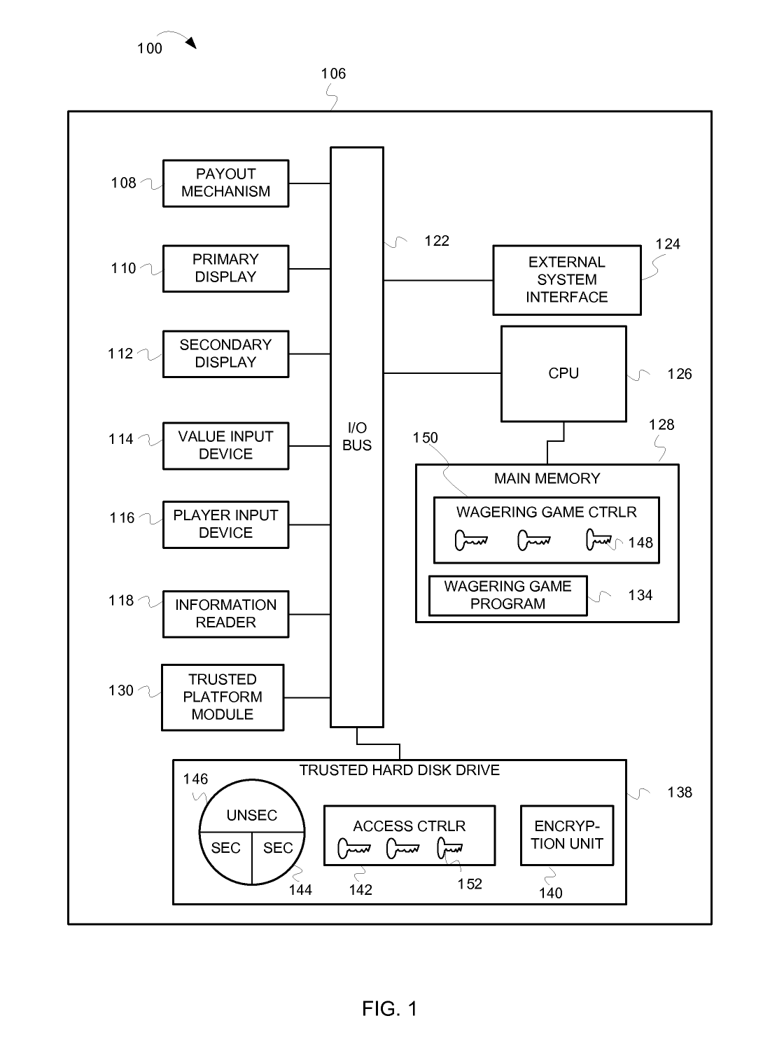

FIG. 1 is a block diagram illustrating a wagering game machine architecture, according to example embodiments of the invention. As shown in FIG. 1, a wagering game machine 106 includes a central processing unit (CPU) 126 connected to main memory 128. The CPU 126 can include any suitable processor, such as an Intel® Pentium processor, Intel® Core 2 Duo processor, AMD Opteron™ processor, or UltraSPARC processor. The main memory 128 includes one or more wagering game programs 134 that present wagering games, such as video poker, video black jack, video slots, video lottery, etc., in whole or part. The main memory 128 also includes a wagering game controller 150 that enables the wagering game program 134 to access certain secure content on a trusted HDD 138. The wagering game controller 150 can be an independent component or part of a wagering game operating system (not shown).

The trusted HDD 138 includes media 146, an encryption unit 140, and an access controller 142. The media 146 is divided into secure partitions 144 and unsecured partitions 146. In some embodiments, the secure partitions 144 store game assets (e.g., audio files, video files, pay tables, etc.) needed by the wagering game program 134 for presenting wagering games. The secure partitions 144 can also store sensitive wagering game information, such as game history information (e.g., final and intermediate game results), player account information (e.g., account balances, amounts wagered, etc.), etc. In some instances, the wagering game controller 150 and wagering game program 134 initially reside on the trusted HDD 138, and are loaded into the main memory 128 during boot-up or some other initialization process. In some embodiments, the encryption unit 140 encrypts content before it is stored on the secure patricians 144. Thus, in some instances, content on the secure partitions 144 is encrypted (at least by the encryption unit 140), whereas content on the unsecured partitions 146 is not encrypted. The encryption unit 140 can be included in the access controller 142 and it can employ any suitable encryption algorithm.

The access controller 142 can limit access to the secure partitions 144. In some embodiments, the access controller 142 grants access to content stored on the secure partitions 144 only after receipt of valid keys. The access controller 142 can compare keys received from the wagering game controller 150 to its keys 152. If the keys match, the access controller 142 may grant access to content stored on the secure partitions 144. In some instances, the keys 152 are injected into the access controller 142 by the manufacturer. In some instances, the keys 152 cannot be modified in the field. In other instances, technicians can change the keys 152 after a trusted HDD 138 has been deployed into a wagering game machine.

The wagering game machine 106 also includes a trusted platform module (TPM) 130. The TPM 130 is a tamper resistant device configured to authenticate components of the wagering machine 106. In some instances, the TPM 130 authenticates components before boot-up. The TPM 130 can authenticate components using keys, digital signatures, serial numbers, model numbers, etc.

The CPU 126 is also connected to an input/output (I/O) bus 122, which can include any suitable bus technologies, such as an AGTL+ frontside bus and a PCI backside bus. The I/O bus 122 is connected to a payout mechanism 108, primary display 110, secondary display 112, value input device 114, player input device 116, information reader 118, and storage unit 130. The player input device 116 can include the value input device 114 to the extent the player input device 116 is used to place wagers. The I/O bus 122 is also connected to an external system interface 124, which is connected to external systems (e.g., wagering game networks).

In one embodiment, the wagering game machine 106 can include additional peripheral devices and/or more than one of each component shown in FIG. 1. For example, in one embodiment, the wagering game machine 106 can include multiple external system interfaces 124 and/or multiple CPUs 126. In one embodiment, any of the components can be integrated or subdivided.

Any component of the architecture 100 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

### Accessing Game Assets from Secure Partitions

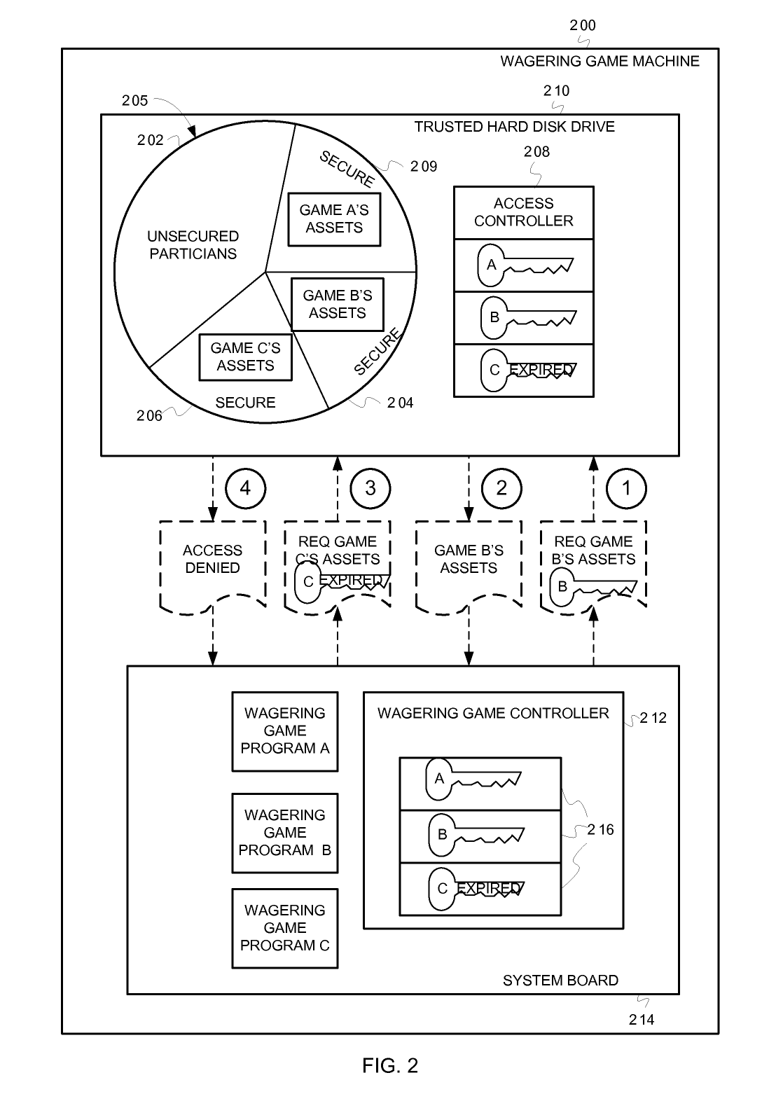

FIG. 2 is a dataflow diagram illustrating operations for accessing wagering game assets stored on secure or partitions of a trusted hard disk drive, according to some embodiments of the invention. In FIG. 2, a wagering game machine 200 includes a trusted HDD 210 and a system board 214. The trusted HDD 210 includes media 205 and an access controller 208. The media 205 is divided into unsecured partitions 202 and secure partitions 204, 206, & 209. The secure partitions include game assets for three wagering game programs. As shown, the secure partition 206 includes game program C's assets, secure partition 204 includes game program B's assets, and secure partition 209 includes game program A's assets. The game assets can include audio files, video files, pay tables, and other information needed for presenting wagering games.

In some embodiments, the content on the secure partitions 204, 206, & 209 was encrypted by the access controller 208, whereas content on the unsecured partitions 202 has not been encrypted by the access controller 208.

The access controller 208 can control access to the secure partitions 206, 204, & 209. The access controller 208 uses its keys (shown as key A, key B, and key C) in a process for granting/denying access to the game assets stored on the secure partitions 204, 206, & 209. In some embodiments, the access controller 208 will provide, upon request, content from the secure partitions (e.g., game assets) without first receiving a valid key. However, the content may be encrypted and therefore unusable. In those embodiments, if the access controller 208 receives a valid key, it will retrieve, decrypt, and deliver content from a secure partition. In other embodiments, the access controller 208 will not retrieve content from secure partitions unless it receives a valid key. The access controller's keys can be alphanumeric strings, codes, or other binary data representing signals or other indicia that can be used for authentication.

The system board 214 includes wagering game programs A, B, & C and a wagering game controller 212. In some embodiments, each of the wagering game programs A, B, & C presents a different wagering game, so each program uses different game assets. The wagering game controller 212 includes keys for accessing game assets stored on the trusted HDD 210. The keys may expire after a specified time. The wagering game controller 212 and wagering game programs can reside in system memory (not shown) and execute on a processor (not shown).

FIG. 2 shows four stages of operations and data flow associated with accessing game assets on the secure partitions. During stage one, wagering game program B executes on the system board 214. During execution, the wagering game program B needs assets stored on the secure partition 204. For example, program B may need audio files from the secure partition for presenting sound for a video poker game. As a result, program B requests the game assets from the wagering game controller 212. In turn, the wagering game controller 212 requests program B's assets from the trusted HDD 210. As shown, the request includes a key associated with program B. The trusted HDD's access controller 208 receives the request and program B's key.

During stage two, the access controller 208 compares the key received from the game controller 212 with a stored version of program B's key. Because the keys match, the access controller 208 retrieves game B's assets from the secure partition 204 and provides them to the game controller 212. In turn, the game controller 212 delivers the game assets to wagering game program B. Wagering game program B can use those assets in presenting wagering games.

During stage three, wagering game program C begins executing on the system board 214. In some instances, the wagering game machine 200 begins executing program C in response to player input (e.g., a player selects a new wagering game). During execution, the wagering game program C needs assets stored on the secure partition 206. For example, program C may need video files from the secure partition for presenting video for a slots game. As a result, program C requests the game assets from the wagering game controller 212. In turn, the wagering game controller 212 requests program C's assets and provides program C's key to the trusted HDD 210. As shown, program C's key is expired (i.e., a specified expiration time has passed).

During stage four, the trusted HDD's access controller 208 compares the key received from the game controller 212 with a stored key associated with wagering game program C. As part of the comparison, the access controller 208 determines that the key is expired (e.g., by comparing its clock to an expiration date included in the key). Because the key is expired, the access controller denies access to program C's game assets.

In some embodiments, the machine 200 and other wagering game machines can be part of a wagering game network. The wagering game network can include wagering game servers that download wagering game assets and other content to the machines' trusted HDDs. The network can also include license servers that distribute keys to the machines' wagering game controllers. Because wagering game assets are stored on secure partitions in the trusted HDDs, wagering game providers can limit use of the wagering game assets. Thus, the wagering game machines and key distribution components (e.g., key server & license server) can combine to form a system for managing digital rights associated with wagering game content. The following two subsections describe wagering game networks and methods for managing digital rights.

### Wagering Game Networks

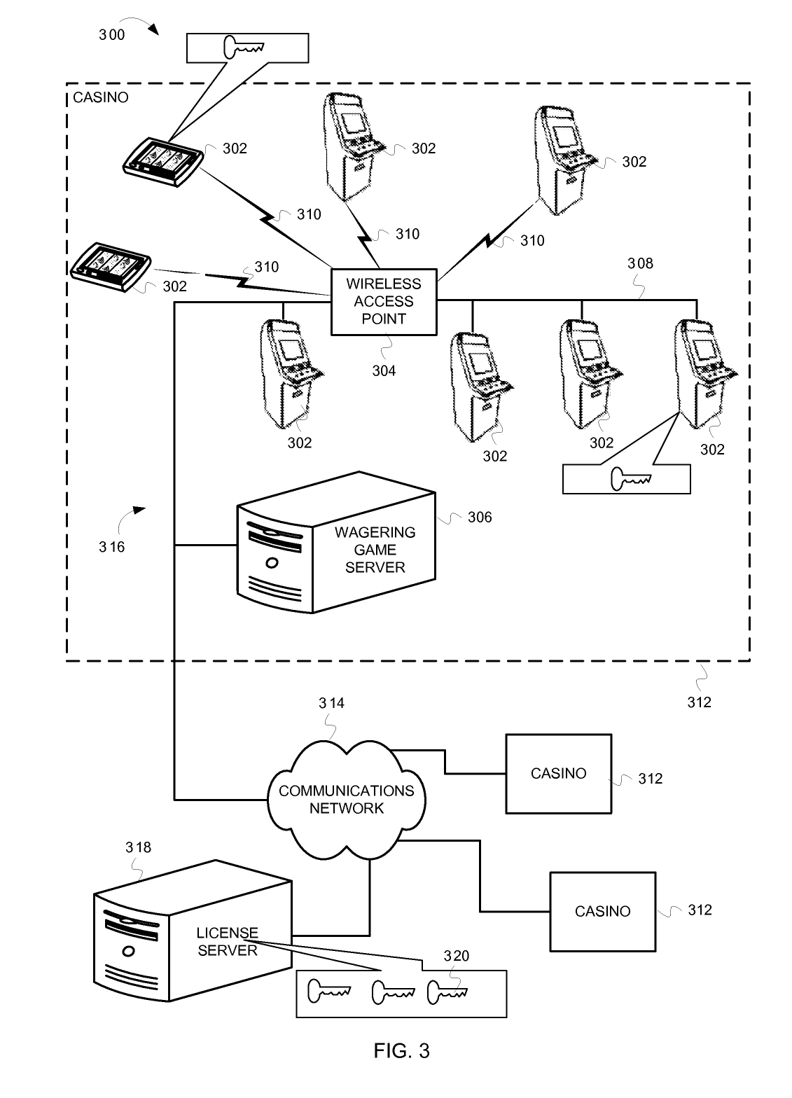

FIG. 3 is a block diagram illustrating a wagering game network 300, according to example embodiments of the invention. As shown in FIG. 3, the wagering game network 300 includes a plurality of casinos 312 connected to a communications network 314.

Each casino 312 includes a local area network 316, which includes an access point 304, a wagering game server 306, and wagering game machines 302. The access point 304 provides wireless communication links 310 and wired communication links 308. The wired and wireless communication links can employ any suitable connection technology, such as Bluetooth, 802.11, Ethernet, public switched telephone networks, SONET, etc.

The wagering game server 306 can serve wagering games and distribute content to devices in the casinos 312 or at other locations on the communications network 314. In some embodiments, the wagering game server 306 transmits wagering game assets to trusted HDDs residing on the wagering game machines 302.

The wagering game machines 302 can include trusted HDDs that store wagering game assets on secure partitions. As described above, the trusted HDDs may require valid keys to access the wagering game assets. The wagering game machines described herein can take any suitable form, such as floor standing models, handheld mobile units, bartop models, workstation-type console models, etc. Further, the wagering game machines 302 can be primarily dedicated for use in conducting wagering games, or can include non-dedicated devices, such as mobile phones, personal digital assistants, personal computers, etc.

In some embodiments, wagering game machines 302 and wagering game servers 306 work together such that a wagering game machine 302 can be operated as a thin, thick, or intermediate client. For example, one or more elements of game play may be controlled by the wagering game machine 302 (client) or the wagering game server 306 (server). Game play elements can include wagering game programs (i.e., executable code) and game assets (e.g., lookup tables, configuration files, game outcomes, audio or visual representations of the game, or the like. In a thin-client example, the wagering game server 306 can perform functions such as determining game outcome or managing assets, while the wagering game machine 302 can present a representation of such outcome or asset modification to the user (e.g., player). In a thick-client example, the wagering game machines 302 can determine game outcomes and communicate the outcomes to the wagering game server 306 for recording or managing a player's account. In some embodiments, whether the machines are thick or thin clients, they access game assets on secure partitions of trusted HDDs.

The wagering game network 300 can also include a license server 318 that distributes keys 320 for accessing wagering game assets stored on trusted HDDs in the wagering game machines. As described above, the keys may expire. The license server can set expiration dates based on license agreements between wagering game providers and wagering game operators (e.g., casinos). In some instances, the license server 318 transmits keys after receiving license fees or other consideration associated with licensing wagering game content.

In some embodiments, the network 300 includes additional components providing functionality that is not directly related to game play. For example, account transactions and account rules may be managed centrally (e.g., by the wagering game server 306) or locally (e.g., by the wagering game machine 302). Other functionality not directly related to game play may include power management, presentation of advertising, software or firmware updates, system quality or security checks, etc.

Any of the wagering game network components (e.g., the wagering game machines 302) can include hardware and machine-readable media including instructions for performing the operations described herein.

### Digital Rights Management

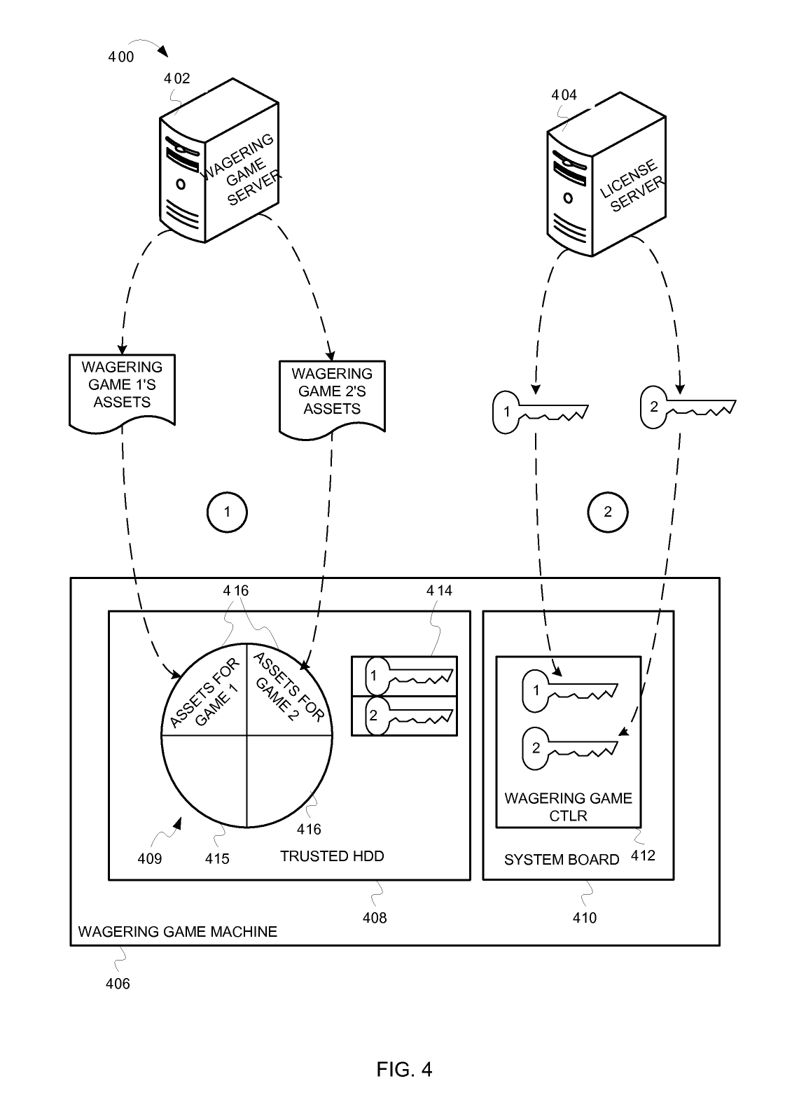

Some embodiments of the inventive subject matter utilize components described above to carry-out methods for managing digital rights associated with wagering game content (e.g., wagering game programs, wagering game assets, wagering game account information, etc.). The discussion of FIG. 4 describes some of these components and methods.

FIG. 4 is a dataflow diagram illustrating a method for managing digital rights associated with wagering game content, according to some embodiments of the invention. In FIG. 4, the dataflow occurs in a wagering game network 400 including a wagering game server 402, license server 404, and wagering game machine 406. The wagering game server 402 can distribute wagering game programs, wagering game assets, wagering game operating system components, etc. The license server 404 can distribute keys to the wagering game machine 406, where the keys are used for accessing content stored on a trusted HDD.

The wagering game machine 406 includes a system board 410 and trusted HDD 408. As shown, the system board 410 includes a wagering game controller 412 configured to store and use keys received from the license server 404. The trusted HDD 408 includes media 409 including secure partitions 416 and an unsecured partition 415. The trusted HDD 408 also includes a key store 414 including keys use for granting or denying access to the content on the secure partitions 416.

The dataflow in FIG. 2 occurs in two stages. During stage one, the wagering game machine 406 receives assets for two wagering games (shown as wagering game 1's assets & wagering game 2's assets). In some embodiments, this occurs during an initialization process in which the wagering game machine 406 executes a minimal boot record that initializes the system board 410 and wagering game controller 412 to a state in which the machine 406 can receive wagering game assets from the wagering game server 402. Also during stage one, the wagering game machine can request other components (e.g., operating system components, wagering game programs, player account information, etc.) from the wagering game server 404. Upon receipt, the machine 406 stores the wagering game assets (assets for games 1 & 2) on secure partitions 416 on the trusted HDD 408. The machine 406 can store the other wagering game content on the unsecured partition 415. Also during stage one, the wagering game machine 408 can launch a wagering game operating system and wagering game program.

Before a wagering game program can access the wagering game assets, the wagering game controller 412 must have keys for accessing secure partitions 416. During stage two, the wagering game controller 412 acquires the keys (shown as key 1 & key 2) needed for accessing the game assets on the secure partitions 416. In some embodiments, the license server 404 provides keys only for game assets covered by a valid license. Without the keys 1 & 2, wagering game programs running on the system board 410 cannot present wagering games, as they cannot access game assets on the secure partitions 416.

Although the above-noted embodiments can operate as described, other embodiments can operate differently. For example, the wagering game machine 406 can acquire wagering game assets and keys after initialization (e.g., while presenting wagering games, in response to a player selecting a new wagering game type, etc.). In some embodiments, wagering game assets are stored on separate secure partitions. As shown, game 1's assets reside on a first secure partition, whereas game 2's assets reside on a second secure partition. Thus, the keys can be associated with particular partitions, or they can be associated with particular game assets. In some instances the keys expire (e.g., when a license for the game assets expires).

### Resisting Attacks

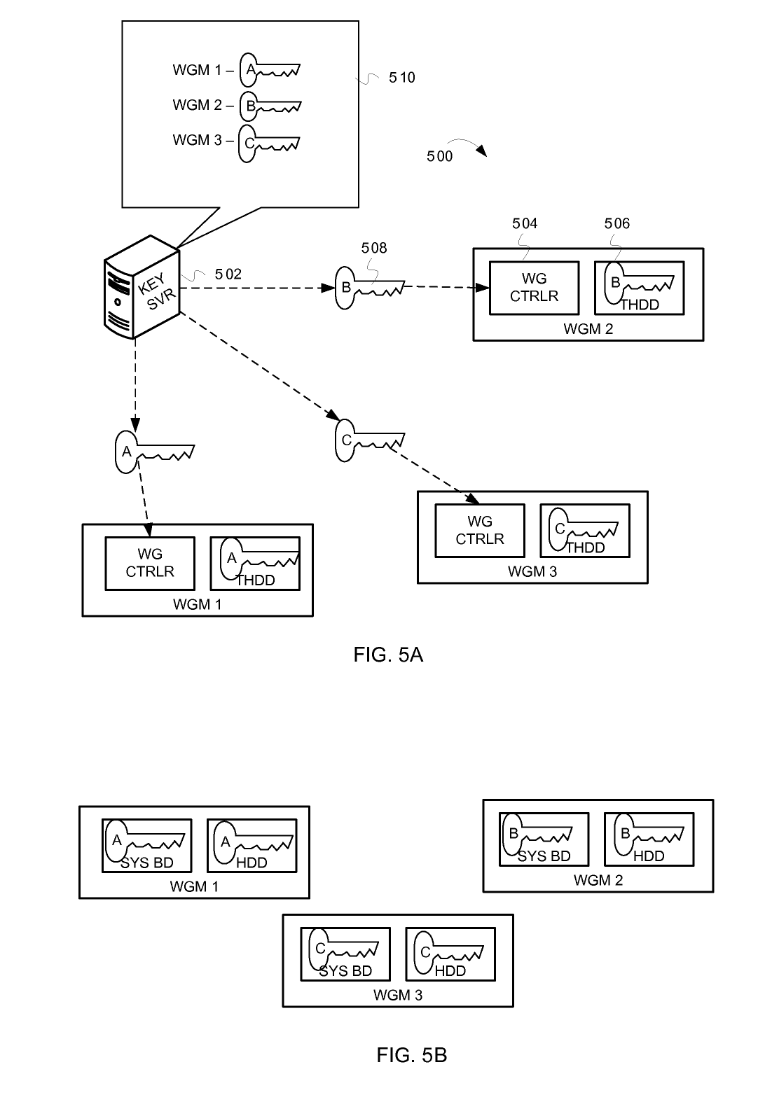

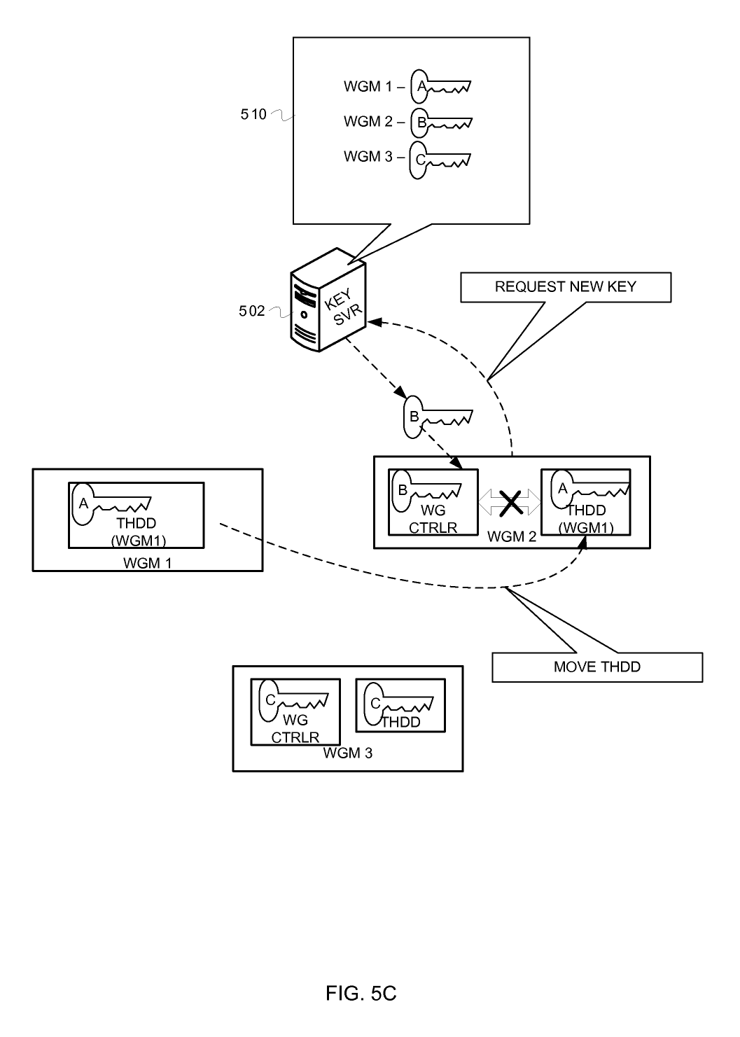

The discussion of FIGS. 5A-5C describes how some embodiments can prevent attackers from moving hard disk drives between wagering game machines. FIG. 5A is a dataflow diagram illustrating how a key server delivers keys for accessing trusted hard disk drives, according to some embodiments of the invention. In FIG. 5A, a wagering game network 500 includes three wagering game machines (shown as wagering game machine 1, wagering game machine 2, and wagering game machine 3) and a key server 502. Each of the wagering game machines includes a trusted hard disk drive 504 and wagering game controller 506. The trusted hard disk drives (HDDs) 504 require keys before they will grant access to secure partitions. Although not shown, the wagering game machines can include other components for presenting wagering games (e.g., the wagering game machines can include components similar to those described in FIG. 1).

The key server 502 can distribute keys to the wagering game machines. The key server 502 may store an association between wagering game machines and keys. For example, in the server's key table 510, key A is associated with wagering game machine 1, key B is associated with wagering a machine 2, and key C is associated with wagering game machine 3. When the wagering game machines are initially deployed into casinos, the wagering game controllers 504 may not include keys needed for accessing secure partitions on the trusted hard disk drives 506. Thus, the machines can request keys from the key server 502. In response, the key server 502 can provide the appropriate keys based on the key table 510. In some embodiments, upon receiving a key request from a wagering game machine, the key server 502 will only transmit a key associated with that machine. Therefore, each of the trusted HDDs can operate in only one particular wagering game machine.

FIG. 5B shows the wagering game machines after the key server 502 has distributed keys to each wagering game controller 504. As a result of the key server 502 distributing keys, wagering game machine 1's controller includes key A, wagering game machine 2's controller includes key B, and wagering game machine 3's controller includes key C. After each wagering game controller receives the proper key, it can access needed wagering game content on the trusted HDD.

Because some embodiments of the key server limit key distribution (e.g., based on key tables), the trusted HDDs are “locked” when they are moved to different wagering game machines. FIG. 5C helps illustrate this concept. In FIG. 5C, an attacker has moved machine 1's trusted HDD into machine 2. Machine 2's wagering game controller does not include the proper key for accessing secure patricians on the HDD from machine 1. That is, machine 2's wagering game controller includes key B, whereas the HDD from machine 1 requires key A before it will grant access to its secure partitions. Machine 2 cannot acquire key A from the key server 502 because the key server 502 will only send key B to machine 2 (see the key table 510). Thus, in some embodiments, moving trusted HDDs between wagering game machines renders them unusable for presenting wagering games.

### Trusting Content on the HDDs

In some embodiments, the wagering game machines can be configured so that only certain applications can store information on the secure partitions. In some embodiments, only trusted applications can store content on the secure partitions. Thus, wagering game controllers can be configured to allow only certain trusted programs to utilize its keys. In some embodiments, wagering game controllers can authenticate application programs before storing content on secure partitions. For example, a wagering game controller can verify a program's digital certificate or other credentials. After verifying the digital certificate, the controller can facilitate writing of content to a secure partition. Because only trusted applications can write to secure partitions, the wagering game content on the secure partitions is trusted. Because the content is trusted, the wagering game machine need not periodically authenticate content stored on the secure partitions. For large HDDs, avoiding such authentication can result in considerable reduction in resource utilization, freeing resources for other tasks. In some instances, avoiding HDD authentication can significantly reduce boot-times.

### Sensitive Content

The wagering game machines and key distribution mechanisms described above can be used for securely storing sensitive wagering game content on wagering game machines. As described above, applications programs cannot access content on the secure partitions unless they have valid keys. Wagering game programs can rely on this layer of access control to retain sensitive wagering game information (e.g., player account information, game history information, etc.) on secure partitions. Because wagering game machines can retain more sensitive wagering game information, they can avoid transmitting the information during peak network traffic times (i.e., wagering game machines can execute load balancing).

### Example Wagering Game Machines

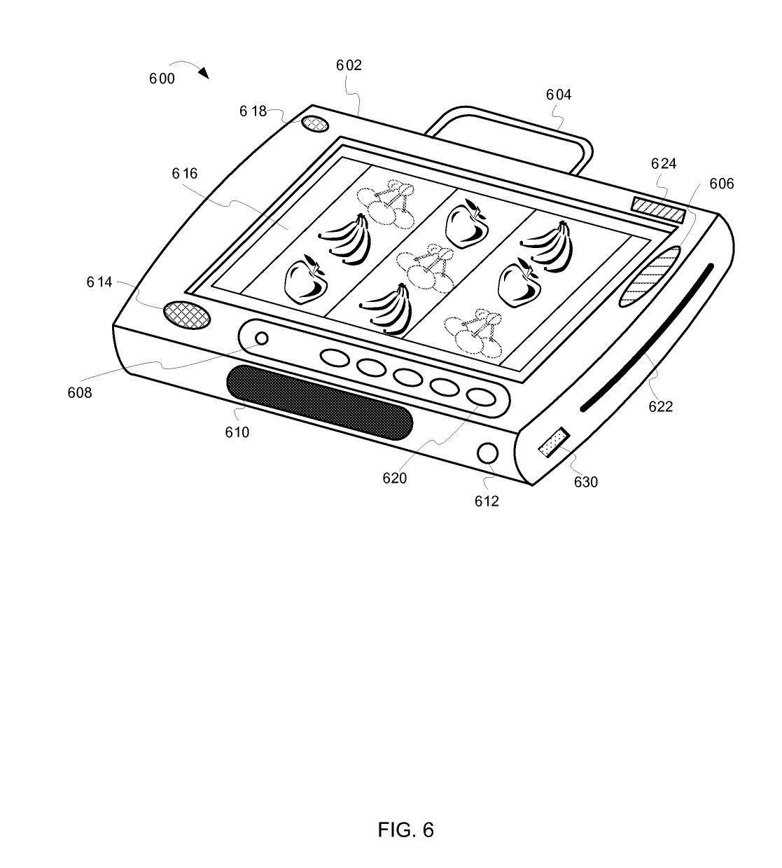

FIG. 6 is an illustration of a mobile wagering game machine 1200, according to some embodiments of the invention. In FIG. 6, the mobile wagering game machine 600 includes a housing 602 for containing internal hardware and/or software such as that described above vis-à-vis FIGS. 1 & 2. In one embodiment, the housing has a form factor similar to a tablet PC, while other embodiments have different form factors. For example, the mobile wagering game machine 600 can exhibit smaller form factors, similar to those associated with personal digital assistants. In one embodiment, a handle 604 is attached to the housing 602. Additionally, the housing can store a foldout stand 610, which can hold the mobile wagering game machine 600 upright or semi-upright on a table or other flat surface.

The mobile wagering game machine 600 includes several input/output devices. In particular, the mobile wagering game machine 600 includes buttons 620, audio jack 608, speaker 614, display 616, biometric device 606, wireless transmission devices 612 and 624, microphone 618, and card reader 622. Additionally, the mobile wagering game machine can include tilt, orientation, ambient light, or other environmental sensors.

In one embodiment, the mobile wagering game machine 600 uses the biometric device 606 for authenticating players, whereas it uses the display 616 and speakers 614 for presenting wagering game results and other information (e.g., credits, progressive jackpots, etc.). The mobile wagering game machine 600 can also present audio through the audio jack 608 or through a wireless link such as Bluetooth.

In one embodiment, the wireless communication unit 612 can include infrared wireless communications technology for receiving wagering game content while docked in a wager gaming station. The wireless communication unit 624 can include an 802.11G transceiver for connecting to and exchanging information with wireless access points. The wireless communication unit 624 can include a Bluetooth transceiver for exchanging information with other Bluetooth enabled devices.

In one embodiment, the mobile wagering game machine 600 is constructed from damage resistant materials, such as polymer plastics. Portions of the mobile wagering game machine 600 can be constructed from non-porous plastics which exhibit antimicrobial qualities. Also, the mobile wagering game machine 600 can be liquid resistant for easy cleaning and sanitization.

In some embodiments, the mobile wagering game machine 600 can also include an input/output (“I/O”) port 630 for connecting directly to another device, such as to a peripheral device, a secondary mobile machine, etc. Furthermore, any component of the mobile wagering game machine 600 can include hardware, firmware, and/or machine-readable media including instructions for performing the operations described herein.

### GENERAL

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A wagering game system configured to render a hard disk drive unusable for presenting wagering games if the hard disk drive is moved between wagering game machines, the system comprising:
a key server configured to transmit a first key to a first wagering game machine and a second key to a second wagering game machine, wherein the key server is configured to not transmit the first key to the second wagering game machine and to not transmit the second key to the first wagering game machine;
the first wagering game machine including,
a first wagering game controller configured to receive the first key from the key server and to facilitate presentation of a first group of wagering games;
a first hard disk drive including,
a first group of secure partitions configured to store a first group of wagering game assets, wherein the wagering game assets are necessary for presenting the first group of wagering games; and
a first access controller configured to receive the first key before providing the first group of wagering game assets using the first key;
the second wagering game machine including,
a second wagering game controller configured to receive the second key from the key server and facilitate presentation of a second group of wagering games;
a second hard disk drive including,
a second group of secure partitions configured to store a second group of wagering game assets, wherein the wagering game assets are necessary for presenting the second group of wagering games; and
an access controller configured to receive the second key before provision of the second group of wagering game assets using the second key, wherein the first key is inoperable to access the second group of wagering game assets and wherein the second key is inoperable to access the first group of wagering game assets.

2. The wagering game system of claim 1, wherein the key server is configured to send the first key to the first wagering game controller and not the second wagering game controller.

3. The wagering game system of claim 1, wherein the first access controller is configured to encrypt the first group of wagering game assets before storage on the first group of secure partitions, and wherein the second access controller is configured to encrypt the second group of wagering game assets before storage on the second group of secure partitions.

4. The wagering game system of claim 1, wherein the keys are represented by one or more of an alphanumeric character string and a signal represented in binary code.

5. The wagering game system of claim 1, wherein the key server is further configured to verify a license for the first and second groups of wagering game assets before transmission of the first and second keys.

6. A wagering game machine comprising:
a secure hard disk drive including,
at least one secure partition configured to store wagering game assets for use in presenting wagering games;
unsecured partitions configured to store wagering game content;
an access controller configured to receive a request to access the wagering game assets and a first access key, to deny the access request if the first access key does not match a second access key, and to allow access to the wagering game assets if the first access key matches the second access key;
a wagering game controller configured to send the request to access the wagering game assets, and to present, after being allowed access to the wagering game assets, to a present wagering game using the wagering game assets.

7. The wagering game machine of claim 6, wherein the access controller is further configured to deny the request if the second access key is expired, wherein expiration of the second access key is based a license term associated with the wagering game assets.

8. The wagering game machine of claim 6, wherein the access controller is further configured to receive the second access key from a license controller after a license royalty has been paid.

9. The wagering game machine of claim 6, wherein the wagering game assets include one or more of audio content, video content, pay tables, and configuration information.

10. The wagering game machine of claim 6, the secure hard disk drive further including,
an encryption unit configured to encrypt, based on the second access key, the wagering game assets for storage on the at least one secure partition, and to decrypt, based on the second access key, the wagering game assets after the access controller allows access to the wagering game assets.

11. A method comprising:
storing wagering game assets on secure partitions of a hard disk drive;
storing a first group of access keys in the hard disk drive, wherein each of the access keys is associated with an expiration date;
receiving a request for some of the wagering game assets and another access key;
determining that the other access key matches one of the first group of access keys;
determining that the expiration date associated with the one of the first group of access keys has not passed;
providing the requested wagering game assets; and
presenting, using the wagering game assets, wagering games.

12. The method of claim 11 further comprising:
encrypting the game assets using the first group of access keys, wherein the encrypting occurs before the storing of the wagering game assets; and
decrypting the game assets using the first group of access keys, wherein the decrypting occurs before the providing.

13. The method of claim 11, wherein the wagering game assets include one or more of audio content, animation content, prerecorded video content, graphical images, and pay tables.

14. The method of claim 11, wherein each key's expiration date is associated with a license to use the game assets.

15. The method of claim 11, wherein each key's expiration date coincides with an expiration date of a license for the wagering game assets.

16. A wagering game network comprising:
a plurality of wagering game machines, wherein one or more of the wagering game machines includes,
a secure hard disk drive including,
wagering game assets for use in presenting wagering games; and
an access controller configured to receive access keys;
grant access to the wagering game assets if the access keys match stored keys;
deny access to the wagering game assets if the access keys do not match the stored keys;
a central processing unit configured to
initiate receipt of the access keys over a network;
transmit the access keys to the secure hard disk drive;
receive the wagering game assets from the secure hard disk drive; and
present wagering games using the wagering game assets;
a licensing server configured to distribute, over a network, the access keys to the one or more wagering game machines;
a wagering game server configured to deliver, over the network, the wagering game assets to the one or more wagering game machines.

17. The wagering game network of claim 16, wherein the wagering game assets include one or more of audio content, animation content, prerecorded video content, graphical images, and pay tables.

18. The wagering game network of claim 16, wherein the access keys expire in accordance to a license to use the game assets.

19. The wagering game network of claim 16, wherein the central processing unit does not validate the wagering game assets after receipt from the wagering game server.

20. The wagering game network of claim 16, wherein the central processing unit is further configured to
receive, from the hard disk drive, a first identifier associated of the hard disk drive; and
halt operations if the first identifier does not match a second identifier accessible to the processor.

21. An apparatus comprising:
means for storing wagering game assets on secure partitions of a hard disk drive;
means for storing a first group of access keys in the hard disk drive, wherein each of the access keys is associated with an expiration date;
means for receiving a request for some of the wagering game assets and another access key;
means for determining that the other access key matches one of the first group of access keys;
means for determining that the expiration date associated with the one of the first group of access keys has not passed;
means for providing the requested wagering game assets; and
means for presenting, using the wagering game assets, wagering games.

22. The apparatus of claim 21 further comprising:
means for encrypting the game assets using the first group of access keys, wherein the encrypting occurs before storage of the wagering game assets; and
decrypting the game assets using the first group of access keys, wherein the decrypting occurs before the provision of the requested wagering game assets.

23. The apparatus of claim 21, wherein the wagering game assets include one or more of audio content, animation content, prerecorded video content, graphical images, and pay tables.

24. The apparatus of claim 21, wherein each key's expiration date is associated with a license to use the game assets.

25. The apparatus of claim 21, wherein each key's expiration date coincides with an expiration date of a license for the wagering game assets.
